(19) United States
(12) Patent Application Publication
(10) Pub. No.: US 2015/0354479 A1
(43) Pub. Date: Dec. 10, 2015

(54) IMPROVING ENGINE PERFORMANCE BY ADJUSTING ANGULAR POSITION SENSOR SIGNAL TIMING

(71) Applicant: BLUTIP POWER TECHNOLOGIES INC., Mississauga (CA)

(72) Inventors: ANDREW HARLAND LINDSAY, Georgetown (CA); KEVIN MICHAEL DAGENAIS, Surrey (CA); FRANK JOSE REVOREDO, Toronto (CA)

(21) Appl. No.: 14/649,169

(22) PCT Filed: Dec. 4, 2013
(86) PCT No.: PCT/IB2013/002922

§ 371 Date: Jun. 2, 2015

Related U.S. Application Data
(60) Provisional application No. 61/733,345, filed on Dec. 4, 2012.

(51) Int. Cl. F02D 41/00; F02D 41/30

(52) U.S. Cl. CPC F02D 41/009; F02D 41/3005

(57) ABSTRACT

Adjusting an angular position sensor signal of an engine operatively coupled to an engine controller, by, at the engine controller: Receiving signal characterization information having been determined based on an angular position sensor signal sample via a communications network from a remote computer system. Generating a time-adjusted angular position sensor signal based on the angular position sensor signal and the signal characterization information. Also, remotely characterizing an angular position sensor signal of an engine operatively coupled to an engine controller, by, at a remote computer system: Receiving an angular position sensor signal sample from the engine controller via a communications network. Determining signal characterization information enabling generation of an adjusted angular position sensor signal having an adjustment in time with respect to the angular position sensor signal based on the angular position sensor signal sample. Sending the signal characterization information to the engine controller via the communications network.

### CROSS-REFERENCE

The present application claims priority to U.S. Provisional Patent Application Ser. No. 61/733,345, filed Dec. 4, 2012, entitled “Method and System for Improving Fuel Economy and Controlling Engine Emissions”. That application is incorporated herein by reference in its entirety.

### FIELD

The present technology relates to methods of, and devices and systems for, improving engine performance by adjusting angular position sensor signal timing.

### BACKGROUND

The adjustment of fuel injection timing is a common technique used to tune engines to improve performance according to one or more performance metrics such as fuel economy, power, reliability, and/or emission characteristics.

The timing of fuel injection is normally controlled by an engine's engine control module (also referred to as an “ECM”, an engine control unit, or “ECU”), which, as the name suggests, is an electronic module that controls various functions of the engine and its components. The engine control module controls the timing (and other characteristics) of fuel injection into the engine cylinders through, amongst other things, receiving one or more angular position sensor signals indicative of the angular position of the engine (determined by the angular position of a rotating engine component such as the engine's crankshaft or camshaft). The engine control module generates a fuel injection actuator signal based in part on the angular position sensor signal(s) and sends the fuel injection actuator signal to the fuel injector(s). More specifically, an engine control algorithm of the engine control module uses one or more timing parameters to determine the timing of the fuel injection actuator signal taking into account the waveform characteristics of the angular position sensor signal(s), such as the frequency, timing, or pattern of transitions between low voltage and high voltage states.

The engine control module's timing parameters target an angular position of the engine at which fuel is injected into the engine, and they are typically fixed based on anticipated timing characteristics of the engine's sensors and actuators established through benchmark testing of one or more engines of the same type and/or model, such that after installation of the engine control module with the engine, they are no longer modified. Such fixed timing parameters are commonly referred to in the art as a fuel injection “map”. They are typically downloaded by (or for) the engine original equipment manufacturer (“OEM”) into the engine control module at the time of engine manufacture or assembly and engine OEM's rarely, if ever, provide subsequent engine operators with a means for installing new or updated maps into the engine control module.

While such fixed timing parameters may generally lead to satisfactory engine performance according to a predetermined performance metric (or balance of performance metrics) such as fuel economy, power, reliability and/or emissions characteristics, an individual engine operator may assign a higher or lower priority to one or more particular performance metrics. In the absence of a mechanism for updating the timing parameters of the engine control module to tune the angular position of the engine at which fuel is injected into the engine, an opportunity to customize performance characteristics of the engine according to the particular needs or desires of an individual engine operator is lost.

In International Patent Publication No. WO 2011/150487 A1 (entitled Method and System for Improving Fuel Economy and Controlling Emissions, published Dec. 8, 2011, filed as PCT/CA2010/000831 on May 31, 2010—annexed to and a part of the '345 provisional application referred to above and incorporated herein by reference), the creators of the present technology describe a solution whereby the fuel-injection timing of an engine may be adjusted despite the fixed timing parameters of the engine control module. The solution presented therein involves the insertion of an additional electronic component, an “engine controller”, into the signal path between the angular position sensor of the engine and the angular position sensor input of the engine control module, the engine controller being configurable to either advance or delay the angular position sensor signal. Because the engine control module is unaware of the presence of the engine controller, it continues to control the engine on the basis of the adjusted angular position sensor signal as if it were the original, unadjusted angular position sensor signal generated by the engine. Therefore, by adjusting the timing of the adjusted angular position sensor signal with respect to the original angular position sensor signal, the engine controller indirectly controls fuel injection timing as the engine control module will cause the injection of fuel into the cylinder(s) on the basis of the falsified engine angular position as opposed to the engine's then actual angular position. Various performance characteristics of the engine that depend on fuel injection timing (and optionally, the timing of other engine actuators such as variable valve actuators) may thus be tweaked by the engine controller.

While the engine controller technology as described in the abovementioned WO '487 patent publication (hereinafter referred to as “the WO '487 technology”) is certainly adequate for its intended purposes, it nevertheless presents inconveniences and leaves room for improvement.

### SUMMARY

It is thus an object of the present technology to provide improvements to existing methods, devices and/or systems for adjusting fuel-injection timing for an engine, and more specifically, to ameliorate at least an inconvenience of the WO '487 technology.

A first inconvenience that may be present in the WO '487 technology concerns the process of “characterizing” the angular position sensor signal of the engine, which is performed in order to facilitate adjustment of the angular position sensor signal. Signal characterization is particularly important when the signal is to be advanced in time, as it provides signal characterization information enabling anticipation of the angular position sensor signal. For example, the signal characterization information may include means for recognizing one or more patterns in the angular position sensor signal, thus enabling the engine controller to anticipate a continuation of an expected pattern upon observing the beginning of that pattern. The WO '487 technology is inconvenient in regard to signal characterization because it requires intervention by a technician situated near the engine and the engine controller for two reasons: first, because engine controllers of the sort described in the WO '487 patent publication are not commonly known and engine operators have neither the training nor the hardware and/or software required to perform the signal characterization, and second, because any errors in the signal characterization information which are not quickly detected could negatively impact engine performance or even the engine itself. The WO '487 technology requires users to address these issues with the help of a technician located on site to supervise characterization of the angular position sensor signal and verify engine operation once the signal characterization information is put into use by the engine controller.

The present technology improves upon the WO '487 technology by providing methods, devices and systems for performing the characterization of the angular position sensor signal using a remote computer system. The engine controller is equipped with a communications interface configured to communicate with the remote computer via a communications network (such as the Internet, a wireless telephone network, a wireless local area network, or some combination thereof). The engine controller may be configured to record the sample and send it to the remote computer as an automated process without needing a technician to be co-located with the engine controller. Moreover, according to the present technology, the engine controller may be configured to verify that the signal characterization information received from the remote computer is substantially consistent with the angular position sensor signal read by the engine controller from the engine while the engine is in operation. In some cases, the engine controller may only adjust the angular position sensor signal based on the signal characterization if the automated verification of the signal characterization information is successful. Optionally, if the verification fails, the engine controller may simply pass through the angular position sensor signal unadjusted (or having a zero adjustment), allowing the engine control module to control the engine as though the engine controller were not installed. The verification process thus allows signal characterization information to be used by an engine controller without direct supervision by a technician, thus further enabling remote signal characterization.

Thus, in a first aspect, various implementations of the present technology provide a method of adjusting an angular position sensor signal of an engine operatively coupled to an engine controller, the method comprising, at the engine controller:
receiving signal characterization information via a communications network from a computer system remote from the engine controller, the signal characterization information having been determined based on an angular position sensor signal sample;
receiving the angular position sensor signal from an angular position sensor of the engine; and
generating an adjusted angular position sensor signal based on the angular position sensor signal and the signal characterization information, the adjusted angular position sensor signal having an adjustment in time with respect to the angular position sensor signal.

Those skilled in the art will appreciate that the appropriate adjustment in time used to target a particular adjustment to the angular position of the engine at which fuel is injected into the engine will vary as a function of engine speed. Specifically, the adjustment in time corresponding to a particular angular adjustment is shorter at high engine speeds than at low engine speeds. As such, generation of the adjusted angular position sensor signal may include determining the engine speed and translating a target angular adjustment into a corresponding adjustment time by which to advance or delay the adjusted angular position sensor signal with respect to the angular position sensor signal.

In some implementations, receiving the signal characterization information includes receiving signal characterization information enabling prediction of a future value of the angular position sensor signal based on a history of angular position sensor signal values. For example, the signal characterization information may include information about a recurring pattern in the angular position sensor signal, such that one or more values of the angular position sensor signal which normally occur later in the pattern may be anticipated once the beginning of the pattern is observed. In some further implementations, receiving the angular position sensor signal includes receiving the history of angular position sensor signal values, and generating the adjusted angular position sensor signal includes (i) predicting the future value of the angular position sensor signal based on the signal characterization information and the history of angular position sensor signal values, and (ii) generating the adjusted angular position sensor signal according to the future value of the angular position sensor signal, thereby advancing the adjusted angular position sensor signal with respect to the angular position sensor signal. Continuing the example, the adjusted angular position sensor signal would be generated according to the value(s) anticipated to occur later in the pattern upon observation of the series of values constituting the beginning of the pattern. The “history” of angular position sensor signal values may but need not be made up exclusively of past values, such that the history of values may or may not include a present value of an angular position sensor signal. The history of angular position sensor signal values could be a history of values of the angular position sensor signal in respect of which the future value is to be predicted, for example a future value of a crankshaft sensor signal may be predicted based on one or more observed values of that crankshaft sensor signal. Alternatively, the history of angular position sensor signal values could be a history of values of another angular position sensor signal, for example a future value of a crankshaft sensor signal may be predicted based on one or more observed values of a camshaft sensor signal, perhaps based on signal characterization information indicative of a correlation between a pattern the camshaft sensor signal and a subsequent appearance of the future value of the crankshaft signal.

In order to make sure that the signal characterization information received by the engine controller is appropriate for use in adjusting the angular position sensor signal received from the engine, the present technology enables the engine controller to verify that the signal characterization information and the actual angular position sensor signal are consistent. Thus, in some implementations, the method further comprises verifying a consistency of the signal characterization information with respect to the angular position sensor signal. In some further implementations, verifying the consistency of the signal characterization information with respect to the angular position sensor signal includes verifying that the angular position sensor signal includes a waveform characteristic that is expected based on the signal characterization information. Various types of waveform characteristics are envisioned. For example, in some yet further implementations, the angular position sensor signal includes a rectangular waveform, and the waveform characteristic is one selected from a group consisting of pulse width and number of pulses per engine revolution of the rectangular waveform. In other yet further implementations, the waveform characteristic is a periodically repeating characteristic portion (e.g. a recurring pattern in the angular position sensor signal).

Other techniques for verifying the consistency of the signal characterization information and the angular position sensor signal are also envisioned. For example, in some implementations, verifying the consistency of the signal characterization information with respect to the angular position sensor signal includes verifying that a predictive accuracy of the angular position sensor signal based on the signal characterization information is not less than a threshold predictive accuracy. If predictions of future values of an angular position sensor signal often turn out to be wrong, the signal characterization information on the basis of which the predictions are made may not be consistent with the angular position sensor signal.

If the signal characterization information appears to be inconsistent with the observed angular position sensor signal, it may be prudent not to adjust the angular position sensor signal on the basis of that signal characterization information. Thus, in some implementations, generating an adjusted angular position sensor signal based on the angular position sensor signal and the signal characterization information is generating an adjusted angular position sensor signal based on the angular position sensor signal and the signal characterization information if and only if the consistency of the signal characterization information with respect to the angular position sensor signal is verified. Otherwise, the angular position sensor signal may be forwarded to the engine control module unadjusted, enabling the engine control module to control the engine using its usual, default fuel injection timing.

In order to perform characterization of the angular position sensor signal, a sample of a representative signal may first be recorded. In some implementations, the engine controller is configured to record a sample of the angular position sensor signal and send the sample to the remote computer via the communications network, whereupon the remote computer system is able to determine the signal characterization information and send it to the engine controller. Thus, in some implementations, the method further comprises, prior to receiving the signal characterization information:
recording the angular position sensor signal sample being a sample of the angular position sensor signal received from the angular position sensor of the engine; and
sending the angular position sensor signal sample via the communications network to the computer system.

In other implementations, the remote computer system first determines the signal characterization information based on a sample of an angular position sensor signal of a first engine, then sends the signal characterization information to an engine controller for use with a second engine similar to the first engine expected to generate a substantially similar angular position sensor signal (e.g. an engine of the same type and/or model). Thus, in other implementations, the angular position sensor signal sample is a sample of an angular position sensor signal of a second engine other than the engine, the second engine being of at least one of a same type and a same model as the engine.

Along with the angular position sensor signal and the signal characterization information and the angular position sensor signal, the engine controller may also generate the adjusted angular position sensor signal based on timing adjustment instructions (e.g. an engine control algorithm, timing map, or other timing information indicative of the amount of time to adjust the angular position sensor signal under various operating conditions). Thus, in some implementations generating an adjusted angular position sensor signal based on the angular position sensor signal and the signal characterization information is generating an adjusted angular position sensor signal based on the angular position sensor signal, the signal characterization information, and timing adjustment instructions.

In some implementations, the adjustment in time is zero. This could occur for a number or reasons. For example, the predetermined fuel injection timing of the engine control module may already be effective at achieving good engine performance under certain operating conditions, such that when those operating conditions occur, the engine controller should not alter the timing at all. Another reason the adjustment time may be zero is if the engine controller detects that the signal characterization information is not sufficiently consistent with the observed angular position sensor signal to be confident that an adjusted angular position sensor signal having a non-zero adjustment time would improve engine performance.

Once that adjusted angular position sensor signal has been generated, it may be applied to an engine control module to effect the desired changes to the engine's performance. Thus, in some implementations, the method further comprises, after generating the adjusted angular position sensor signal, sending the adjusted angular position sensor signal to an engine control module configured to control fuel injection of the engine based on received angular position sensor signals.

In a second aspect, the present technology also enables those skilled in the art to develop a remote computer system for performing signal characterization of the angular position sensor signal of one or more engines at a distance. Thus, various implementations of the present technology provide a method of remotely characterizing an angular position sensor signal of an engine operatively coupled to an engine controller, the method comprising, at a computer system remote from the engine controller:
receiving an angular position sensor signal sample from the engine controller via a communications network, the angular position sensor sample being a sample of the angular position sensor signal received from an angular position sensor of the engine;
determining signal characterization information based on the angular position sensor signal sample, the signal characterization information enabling generation of an adjusted angular position sensor signal having an adjustment in time with respect to the angular position sensor signal; and
sending the signal characterization information to the engine controller via the communications network.

In some implementations, determining the signal characterization information includes determining signal characterization information enabling prediction of a future value of the angular position sensor signal based on a history of angular position sensor signal values, and sending the signal characterization information includes sending the signal characterization information enabling prediction of the future value of the angular position sensor signal based on the history of angular position sensor signal values.

Because like engines may generate like angular position sensor signals, signal characterization information in respect of one engine may be fit for use with another engine in some cases. Thus, in some implementations, the method further comprises sending the signal characterization information to a second engine controller other than the engine controller, the second engine controller being operatively coupled to a second engine other than the engine, the second engine being of at least one of a same type and a same model as the engine.

A second inconvenience of the WO '487 technology is that the timing adjustment instructions (e.g. engine control algorithm, timing map, timing information, etc.) of the engine controller either cannot be updated after installation or can only be updated by an on-site technician equipped with appropriate hardware and software. This makes it unfeasible to implement a timing adjustment instruction optimization strategy requiring relatively frequent updates to fuel infection timing of an installed engine, for example to detect correlations between various potential timing adjustment instructions and the engine performance of particular engine types (or models) in particular operating environments (temperature, humidity, air pressure, etc.) under particular operating conditions (e.g. engine speed, engine load, etc.). Therefore, while the WO '487 technology enables, for example, setting all engines of a particular model to use a generic set of timing adjustment instructions established in advance for that engine model, it does not facilitate the implementation of a rapidly adaptable optimization strategy taking into account a particular set of environmental and operating conditions faced by a particular engine while in operation.

The present technology overcomes this inconvenience of the WO '487 technology by making it possible to update the timing adjustment instructions from a remote computer via a communications network. This not only reduces the time and cost associated with sending a technician to the location of the engine, but also enables finer optimization of the timing adjustment instructions by enabling continuous testing of different timing adjustment instructions in particular contexts. Moreover, by allowing for frequent and rapid collection of performance data from multiple engines, the present technology enables detection of correlations between the timing adjustment instructions employed and resulting performance in real operational contexts, as well as deployment of new timing adjustment instructions derived from analysis of such correlations.

Thus, in another aspect, various implementations of the present technology provide a method of improving performance of an engine according to a performance metric, the engine including an engine control module structured and configured to control fuel injection timing of the engine based on an angular position sensor signal from an angular position sensor of the engine, the method comprising, at an engine controller operatively coupled to the angular position sensor and the engine control module:
receiving timing adjustment instructions via a communications network from a computer system remote from the engine controller, the timing adjustment instructions yielding an amount of time by which to adjust the angular position sensor signal based on an operating condition of the engine, the angular position sensor signal adjusted by the amount of time being usable by the engine control module to yield improved performance of the engine according to the performance metric;
receiving the angular position sensor signal from the angular position sensor;
determining the operating condition of the engine;
generating an adjusted angular position sensor signal having an adjustment in time with respect to the angular position sensor signal by the amount of time yielded by the timing adjustment instructions based on the operating condition of the engine, the adjusted angular position sensor signal being generated with sufficient characteristics of the angular position sensor signal to be compatible with the engine control module; and
sending the adjusted angular position sensor signal to the engine control module to yield improved performance of the engine according to the performance metric.

The performance metric could be any characteristic of engine performance that someone may want to improve. In some implementations, the performance metric is at least one of fuel economy and emissions output. In other implementations, the performance metric could be, as non-limiting examples, power or reliability. In some implementations, the performance metric is a single performance metric, while in other implementations, the performance metric could be a combination of different metrics, for example a balance of fuel economy and power.

The timing adjustment instructions (e.g. engine control algorithm, timing map, timing information, etc.) may yield an adjustment in time with which the angular position sensor signal ought to be shifted based on various operating conditions of the engine. As non-limiting examples, the operating conditions of the engine on the basis of which the adjustment in time is determined may be engine load and/or engine speed. Thus, in some implementations, the operating condition of the engine is one of a load of the engine and a speed of the engine. Other operating conditions, such as environmental conditions (temperature, humidity, air pressure, etc.), may also be taken into account in some implementations.

In some implementations, generating the adjusted angular position sensor signal includes generating the adjusted angular position sensor signal based on the angular position sensor signal and signal characterization information.

Some implementations of the present technology combine the remote signal characterization aspect with the remote configuration of timing adjustment instructions aspect. Thus, in some implementations, the computer system is a first computer system, and the method further comprises receiving the signal characterization information via the communications network from a second computer system remote from the engine controller, the signal characterization information having been determined based on an angular position sensor signal sample. In some further implementations, receiving the signal characterization information includes receiving signal characterization information enabling prediction of a future value of the angular position sensor signal based on a history of angular position sensor signal values. In some yet further implementations, receiving the angular position sensor signal includes receiving the history of angular position sensor signal values; and generating the adjusted angular position sensor signal includes (i) predicting the future value of the angular position sensor signal based on the signal characterization information and the history of angular position sensor signal values and (ii) generating the adjusted angular position sensor signal according to the future value of the angular position sensor signal, thereby advancing the adjusted angular position sensor signal with respect to the angular position sensor signal.

Some implementations which include reception of the signal characterization also perform a verification of the signal characterization information with respect to the observed angular position sensor signal. Thus, in some further implementations, the method further comprises verifying a consistency of the signal characterization information with respect to the angular position sensor signal. In some such implementations, verifying the consistency of the signal characterization information with respect to the angular position sensor signal includes verifying that the angular position sensor signal includes a waveform characteristic that is expected based on the signal characterization information. As a non-limiting example, in some such implementations, the angular position sensor signal includes a rectangular waveform, and the waveform characteristic is one selected from a group consisting of pulse width and number of pulses per engine revolution of the rectangular waveform. As another non-limiting example, in some implementations, the waveform characteristic is a periodically repeating characteristic portion (e.g. a repeating pattern in the signal). In some implementations, verifying the consistency of the signal characterization information with respect to the angular position sensor signal includes verifying that a predictive accuracy of the angular position sensor signal based on the signal characterization information is not less than a threshold predictive accuracy.

The signal characterization may be determined based on a sample of the angular position sensor signal of the engine or of another engine of the same type and/or model. Thus, in some implementations, the method further comprises, prior to receiving the signal characterization information via the communications network from a second computer system remote from the engine controller: recording the angular position sensor signal sample being a sample of the angular position sensor signal received from the angular position sensor of the engine; and sending the angular position sensor signal sample via the communications network to the second computer system. In other implementations, the angular position sensor signal sample is a sample of an angular position sensor signal of a second engine other than the engine, the second engine being of at least one of a same type and a same model as the engine.

In implementations combining remote signal characterization and remote configuration of the timing adjustment instructions, each of these functions may be performed by separate remote computer system or by a same remote computer system. Thus, in some implementations, the second computer system is the first computer system.

In another aspect, the present technology provides for determination of the timing adjustment instructions and sending of the timing adjustment instructions to the engine controller by a remote computer system. Thus, in another aspect, various implementations of the present technology provide a method of improving performance of an engine according to a performance metric, the engine including (i) an engine control module structured and configured to control fuel injection timing of the engine based on an angular position sensor signal from an angular position sensor of the engine and (ii) an engine controller operatively coupled to the angular position sensor and the engine control module, the method comprising, at a computer system remote from the engine controller:
determining timing adjustment instructions yielding an amount of time by which to adjust the angular position sensor signal based on an operating condition of the engine, an adjusted angular position sensor signal adjusted by the amount of time being useable by the engine control module to yield improved performance of the engine according to the performance metric; and
sending the timing adjustment instructions to the engine controller via a communications network.

The remote computer system may be operated by a user, who may select an appropriate set of timing adjustment instructions for the engine controller, for example by indicating the type or model of the engine. Thus, in some further implementations, determining the timing adjustment instructions includes receiving an indication of at least one of a type and a model of the engine from a user of the computer system. Other implementations may operate in a more automatic fashion, without input from a user.

The same remote computer system may combine various aspects of the present technology, such as the signal characterization aspect and the timing adjustment instruction determination aspect. Thus, in some further implementations, the method further comprises, prior to determining the timing adjustment instructions:
receiving an angular position sensor signal sample from the engine controller via the communications network;
determining signal characterization information based on the angular position sensor signal sample, the signal characterization information enabling generation of the adjusted angular position sensor signal; and
sending the signal characterization information to the engine controller via the communications network.

In some further implementations, the remote computer system may use the signal characterization information to determine appropriate timing adjustment instructions. As non-limiting examples, the signal characterization information could be compared to that of other engines as a means of identifying at least one of a type and a model of the engine, and timing adjustment instructions appropriate for the identified engine type and/or model could be selected. Thus, in some implementations, determining the timing adjustment instructions includes determining the timing adjustment instructions based on the signal characterization information.

In some implementations, once it is determined which timing adjustment instructions should be sent, they are retrieved from a volatile or non-volatile memory (RAM, ROM, disk drive, solid-state drive, or any other computer-readable memory) of the computer system and sent to the engine controller. Thus, in some implementations, the method further comprises, after determining the timing adjustment instructions and before sending the timing adjustment instructions, retrieving the timing adjustment instructions from a memory of the computer system. For example, the timing adjustment instructions may have been previously determined for a different engine, for example a reference engine, which may be an engine connected to various equipment (e.g. a dynamometer) enabling particularly accurate measurement of engine performance according to a performance metric under various conditions. Thus, in some implementations, the timing adjustment instructions are derived from a second engine other than the engine, and in some further implementations, the second engine is a reference engine.

In some such implementations, the timing adjustment instructions may also be of use to other engines. Thus, in some further implementations, the timing adjustment instructions retrieved from the memory are also sent to an engine controller of a third engine.

In some implementations, the remote computer system may receive information about the subsequent performance of the engine while using the timing adjustment instructions. Thus, in some implementations, the method further comprises receiving feedback information with respect to the improved performance of the engine. In some such implementations, the feedback information includes information with respect to at least one of location information of the engine (e.g. latitude, longitude, altitude, attitude (inclination), position relative to a known location, etc.) and environmental conditions of the engine (e.g. temperature, humidity, air pressure). In some implementations, the feedback information may be used to determine updated timing adjustment instructions. Thus, in some implementations, the method further comprises, after receiving the feedback information, sending updated timing adjustment instructions in view of the feedback information to the engine controller via the communications network. In some further implementations, the updated timing adjustment instructions are stored in order to be available to be sent to one or more other engines. Thus, in some further implementations, the method further comprises storing the updated timing adjustment instructions in the memory and sending the updated timing adjustment instructions to the engine controller of the third engine via the communications network.

In some implementations, the feedback information is used to update the timing adjustment instructions of the engine controller and/or one or more other engine controllers in real-time (e.g. shortly after the feedback information is received). Thus, in some implementations, the following occur in real-time: receiving feedback information with respect to the improved performance of the engine; and sending updated timing adjustment instructions in view of the feedback information to the engine controller via the communications network. And in some implementations, the following occur in real-time: receiving feedback information with respect to the improved performance of the engine; and sending updated timing adjustment instructions in view of the feedback information to the engine controller of the third engine via the communications network.

Apart from the methods described hereinabove, the present technology also provides various devices suitable for carrying out the methods, such as various engine controllers and computer systems. Thus, in another aspect, various implementations of the present technology provide an engine controller suitable for intercepting and adjusting an angular position sensor signal from an angular position sensor of an engine being communicated to an engine control module of the engine, the engine controller comprising:
a communications interface for communicating with a computer system remote from the engine;
an input port for receiving the angular position sensor signal;
an output port for sending an adjusted engine actuator signal to the engine control module in place of the angular position sensor signal; and
an electronic module configured for
   receiving the angular position sensor signal via the input port,
   receiving at least one of signal characterization information, a history of angular position sensor signal values, and timing adjustment instructions from the computer system via the communications interface,
   predicting a future value of the angular position sensor signal based on signal characterization information and a history of angular position sensor signal values,
   generating the adjusted angular position sensor signal according to the future value of the angular position sensor signal, the adjusted angular position sensor signal having a time shift with respect to the received angular position sensor signal by an amount of time set according to timing adjustment instructions, and
   sending the adjusted angular position sensor signal via the output port.

As non-limiting examples, the electronic module may be configured using program instructions, field-programmable gate array (FPGA) programming, and/or integrated circuit design. Thus, in some implementations, the electronic module includes at least one processor and a memory having program instructions, and in some implementation, the electronic module includes at least one of a field-programmable gate array and an application-specific integrated circuit.

In some implementations, the electronic module is configured for receiving each of the signal characterization information, the history of angular position sensor signal value, and the timing adjustment instructions from the computer system via the communications interface. In some implementations, the electronic module is further configured for sending an angular position sensor signal sample to the computer system via the communications interface.

In some implementations, the electronic module is further configured for verifying a consistency of signal characterization information received from the computer system with respect to the received angular position sensor signal. In some further implementations, verifying the consistency of the signal characterization information received from the computer system with respect to the received angular position sensor signal includes verifying that the received angular position sensor signal includes a waveform characteristic that is expected based on the received signal characterization information. As a non-limiting example, the received angular position sensor signal may include a rectangular waveform, and the waveform characteristic may be one selected from a group consisting of pulse width and number of pulses per engine revolution of the rectangular waveform. As a second non-limiting example, the waveform characteristic may be a periodically repeating characteristic portion. In some implementations, verifying the consistency of the signal characterization information received from the computer system with respect to the received angular position sensor signal includes verifying that a predictive accuracy of the received angular position sensor signal based on the signal characterization information received from the computer system is not less than a threshold predictive accuracy. In some implementations, the adjusted angular position sensor signal is generated if and only if the consistency of the signal characterization information received from the computer system with respect to the received angular position sensor signal is verified.

In some implementations, the electronic module is further configured for sending feedback information to the computer system via the communications interface.

In another aspect, various implementations of the present technology provide a computer system for improving performance of an engine according to a performance metric, the engine including (i) an engine control module structured and configured to control fuel injection timing of the engine based on an angular position sensor signal from an angular position sensor of the engine and (ii) an engine controller operatively coupled to the angular position sensor and the engine control module, the computer system comprising:
a communications interface for communicating with the engine controller via a communications network;
at least one processor;
a first memory in communication with the at least one processor;
a second memory having program instructions executable by the at least one processor to effect
   determining timing adjustment instructions yielding an amount of time by which to adjust the angular position sensor signal based on an operating condition of the engine, an adjusted angular position sensor signal adjusted by the amount of time being useable by the engine control module to yield improved performance of the engine according to the performance metric, and
   sending the timing adjustment instructions to the engine controller via the communications network;
      the computer system being remote from the engine.

In some implementations, the program instructions further effect receiving an indication of the at least one of a type and a model of the engine from a user of the computer system. In some further implementations, the program instructions further effect, prior to determining the timing adjustment instructions:
receiving an angular position sensor signal sample from the engine controller via the communications network;
determining signal characterization information based on the angular position sensor signal sample, the signal characterization information enabling generation of the adjusted angular position; and
sending the signal characterization information to the engine controller via the communications network.

In some yet further implementations, determining the timing adjustment instructions includes the determining timing adjustment instructions based on the signal characterization information.

In some implementations, the program instructions further effect, after determining timing adjustment instructions and before sending the timing adjustment instructions, retrieving the timing adjustment instructions from the first memory. In some further implementations, the timing adjustment instructions are derived from a second engine other than the engine. In some yet further instructions, the second engine is a reference engine.

In some implementations, the program instructions further effect sending timing adjustment instructions to an engine controller of a third engine.

In some implementations, the program instructions further effect receiving feedback information with respect to the improved performance of the engine. As a non-limiting example, the feedback information may include information with respect to at least one of location information of the engine and environmental conditions of the engine. In some further implementations, the program instructions further effect, after receiving the feedback information, sending updated timing adjustment instructions in view of the feedback information to the engine controller via the communications network. In some further implementations, the program instructions further effect storing the updated timing adjustment instructions in the first memory; and sending the updated timing adjustment instructions to the engine controller of the third engine via the communications network.

In some implementations, the computer system uses the feedback information to send updated timing adjustment instructions to the engine controller or one or more other engine controllers in real time. Thus, in some implementations, the program instructions effect the following occurring in real-time: receiving feedback information with respect to the improved performance of the engine; and sending updated timing adjustment instructions in view of the feedback information to the engine controller via the communications network. And in some implementations, the program instructions effect the following occurring in real-time: receiving feedback information with respect to the improved performance of the engine; and sending updated timing adjustment instructions in view of the feedback information to the engine controller of the third engine via the communications network.

In the context of the present specification, the expression “information” includes information of any nature or kind whatsoever capable of being represented using electrical signals.

In the context of the present specification, a “computer system” is any digital electronic device or combination of digital electronic devices structured and configured for processing information, that is, generating one or more logical output values on the basis of one or more logical input values. Unless otherwise specified, a computer system may or may not include a processor or a plurality of processors configured to process information by executing program instructions (i.e. software).

In the context of the present specification, a computer system may be said to be “remote” from an engine controller if a technician operating the computer system would be too far from the engine controller to physically connect equipment to the engine and/or engine controller so as to directly take measurements of the angular position sensor signal of the engine and/or verify first-hand that the engine is operating properly while being controlled on the basis of an adjusted angular position sensor signal being generated by the engine controller based on the signal characterization information.

In the context of the present specification, the expression “timing adjustment instructions” includes any information which may be used or interpreted by its recipient as an indication of an amount by which a timing of a signal ought to be adjusted. As one skilled in the art would recognize, the degree of precision required in such instructions depends on the extent of any prior understanding about the interpretation to be given to information being exchanged as between the sender and the recipient of the instructions. For example, it may be agreed prior to a communication between a computer system and an engine controller, either via an earlier communication or by design, that the computer system will send an indication of amounts of time by which to adjust the signal under certain conditions. As another example, the computer system may send an indication of a set of target timings that the engine controller should seek to achieve, leaving the engine controller to determine the appropriate amount of time to adjust the signal so as to achieve the target timing as closely as possible. In another example, timing adjustment instructions may be described in terms of a target angular adjustment of the angular position at which fuel is injected into the engine, which the engine controller may translate into an adjustment of time by which to adjust the angular position sensor signal depending on the speed of the engine according to simple calculations widely known to those skilled in the art. A myriad of possibilities exist: all that matters is that the timing adjustment instructions convey information executable or interpretable to yield one or more amounts of time (possibly including a time of zero) by which to adjust the signal under one or more conditions.

In the context of the present specification, the words “first”, “second”, etc. have been used as adjectives only for the purpose of allowing for distinction between the nouns that they modify from one another, and not for the purpose of describing any particular relationship between those nouns. Thus, for example, it should be understood that, the use of the terms “first engine” and “second engine” is not intended to imply any particular order, type, chronology, hierarchy or ranking (for example) of/between the engines.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of a system for improving engine performance illustrating various implementations of the present technology.

FIG. 2 is a high-level diagram depicting engine controllers in communication with a remote computer system according an exemplary networked configuration.

FIG. 3 is a flowchart depicting the steps of a method according to an implementation of the present technology.

FIG. 4 is a diagram showing exemplary camshaft and crankshaft signals.

### DETAILED DESCRIPTION

In the figures there are shown various implementations of the present technology. It is to be expressly understood that the descriptions thereof that follow are intended to be only illustrative examples of the present technology. This description is not intended to define the scope or set forth the bounds of the present technology. In some cases, what are believed to be helpful exemplary modifications of these implementations may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the engine controller 110 and remote computer 120 described herein may provide in certain instances simple implementations of the present technology, and that where such is the case they have been presented in this manner as an aid to understanding. As persons skilled in the art would understand, various implementations of the present technology may be of a greater complexity.

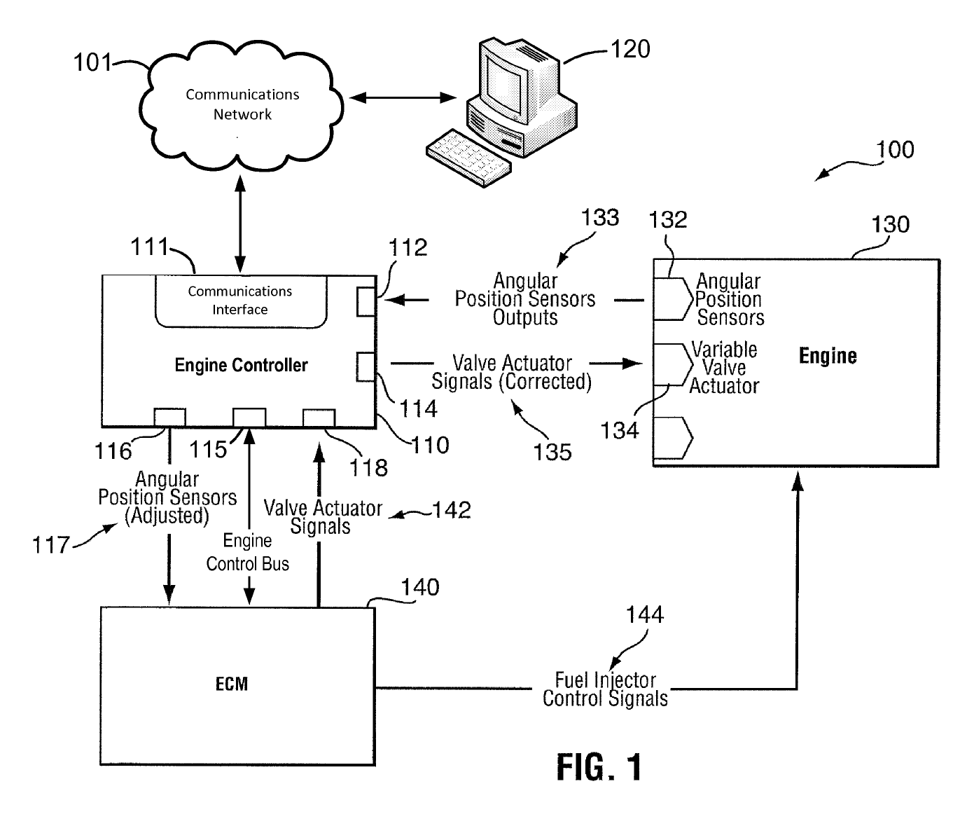

Reference is first made to FIG. 1, which shows a system for improving engine performance according to an implementation of the present technology, indicated generally by reference 100. The system 100 according to an implementation comprises an engine controller 110 which interfaces with an engine (or motor) 130 and an engine control module (ECM) 140. Engine controller 110 includes a communications interface 111 in communication with a remote computer 120 via a communications network 101. The various types of physical connections and communication protocols of communications network 101 are conventional and will not be described in further detail herein. It will be appreciated by those skilled in the art that communications network 101 may comprise any number of communications links enabling relaying of information from the communications interface 111 to the remote computer system 102 and vice versa. As non-limiting examples, communications network 101 may be a public network such as the Internet, a private network such as a local area network (LAN), a combination of public and/or private networks, or a direct communications link such as a wired or wireless communications link

Remote computer 120 comprises one or more electronic devices (e.g. computers, computer components, and/or other electronic devices) and includes hardware structured and configured for communicating with communications interface 111 of engine controller 110 via communications network 101. Remote computer 120 also includes hardware structured and configured for determining signal characterization information based on an angular position sensor signal sample (e.g. a sample of one or more of angular position sensor output signals 133 of engine 130). Remote computer 120 may also include software such as an operating system and a computer algorithm executable by at least one processor to perform the signal characterization.

In this implementation, the engine 130 is configured with angular position sensors 132 and variable valve actuators 134. The angular position sensors 132 comprise sensors, for example, proximity sensors, that are configured to determine the angular position of the engine by detecting or sensing teeth or other indicia on a tone ring associated with the engine camshaft and/or engine crankshaft (not depicted). The angular position sensors 132 generate angular position sensor output signals 133 that are utilized by the engine controller 110 to generate adjusted angular position sensor output signals 117 for use by the engine control module 140. The variable valve actuators (VVA) 134 comprise a conventional mechanism for altering valve lift or duration in the engine 130. The variable valve actuators 134 can be controlled by the engine control module 140, for example as part of a strategy to control engine emissions. According to this aspect, the engine control module 140 generates valve actuator control signals 142 that are intended for the variable valve actuators 134. The valve actuator control signals 142 are intercepted by the engine controller 110 and provide the basis for the generation of corrected or otherwise modified valve actuator signals 135 that are then applied to the variable valve actuator 134, as described in more detail in the WO '487 patent publication.

The engine controller 110 includes an input port 112 for receiving one or more angular position readings or signals from the angular position sensors 132 of the engine 130, and a port 114 for outputting or transmitting adjusted (or corrected) valve actuator signals 135 to the engine 130. As is also shown, the engine controller 110 includes a port 118 for inputting (i.e. intercepting) the valve actuator control signals 142 generated by the engine control module 140 and intended for the variable valve actuator 134 in the engine 130. As is also shown in FIG. 1, the engine controller 110 also includes an output port 116 for outputting adjusted angular position sensor output signals 117 to the engine control module 140. In the exemplary implementation of FIG. 1, engine controller also includes an engine control bus port 115 used to communicate with engine control module 140 (e.g. to request and receive information such as the engine load or engine speed). For example, the engine control bus may be a controller area network (CAN). In various implementations, engine controller 110 may also communicate with other devices (not depicted) connected to the engine control bus, for example to transmit or acquire information about environmental conditions, engine performance information, or other information. As will be described in more detail below, the engine controller 110 is configured (for example, using stored program control, computer or microprocessor executable instructions in firmware or software, a field-programmable gate array, and/or an application specific integrated circuit) to improve performance of the engine 130 according to a performance metric, e.g. fuel economy, by adjusting or varying the fuel injector timing for the engine. The engine controller 110 may also include further digital logic, analog circuits, sensors, transducers and other electronic or electrical hardware appropriately configured to provide the functionality as described herein.

According to one aspect, the engine controller 110 includes an angular position processor module or executable code component (not depicted) configured for receiving and processing the angular position sensor output signals 133 received from the engine 130 (i.e. via the input port 112) and generating the adjusted angular position sensor output signals 117. The adjusted angular position signals 117 are sent to the engine control module 140, which utilizes them according to its predetermined algorithms or control processes (e.g. timing map) to generate fuel injector control signals 144 that control operation of the fuel injectors (not shown) of the engine 130 for improved performance. The operation and control of the fuel injector control signals 144 is otherwise conventional and will not be described in further detail herein. The angular position processor or module in the engine controller 110 may be implemented, for example, as an executable code or software component. According to one aspect, the angular position processor is configured to determine the angular position of the engine 130 by sensing the position of the engine camshaft and/or crankshaft. The camshaft and the crankshaft are typically constructed with gear teeth or other similar indicators on a tone ring that can be detected by a suitably positioned sensor (i.e. the angular position sensors 132) as the engine rotates. The gear teeth typically include one or more uniquely identifiable sections (also known as characterizing sections), for example, one or more teeth having a different size, in order to identify a specific angular position of the engine. According to one aspect, the angular position processor module is configured to intercept the angular position sensor output signals 133, i.e. at the input port 112 on the engine controller 110, and adjust these signals by advancing or delaying their timing in order to achieve improved performance according to the performance metric. The adjusted angular position sensor output signals 117 are outputted to the engine control module 140. The engine control module 140 utilizes the adjusted angular position sensor signals 117 as if they were received directly from the angular position sensors 132, and generates corresponding fuel injector control signals 144 which control the engine 130 and thereby achieve the desired performance characteristics. It will be appreciated that the configuration as shown in FIG. 1 does not require the direct control or adjustment of the fuel injector control signals 144 and thereby does not require extensive modification of the engine control module 140 and facilitates retrofit or after-market installation of the engine controller 110. Thus, in one implementation the engine controller 110 can simply be added to an existing engine (in a truck or earth mover for example) by reconfiguring the wiring (for example) such that the angular position sensor signal 133 is sent to the input port 112 of the engine controller 110 and the adjusted angular position sensor signal 117 is sent from the output ort 116 to the engine controller 110 to the engine control module 140 it place of the angular position sensor signal 133.

In further implementations not depicted, the engine controller 110 may further include a gas injection controller configured to control a gas injection module which injects one or more gases (such as liquefied natural gas, compressed natural gas, liquefied propane gas, hydrogen and/or oxygen) into the engine's air intake manifold, for example in order to improve engine emission quality as described in the WO '487 patent publication.

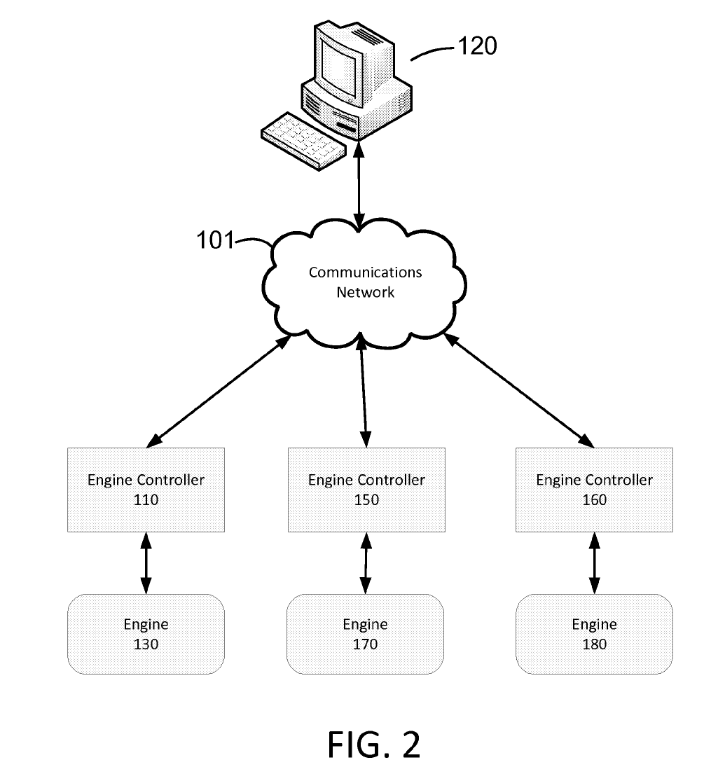

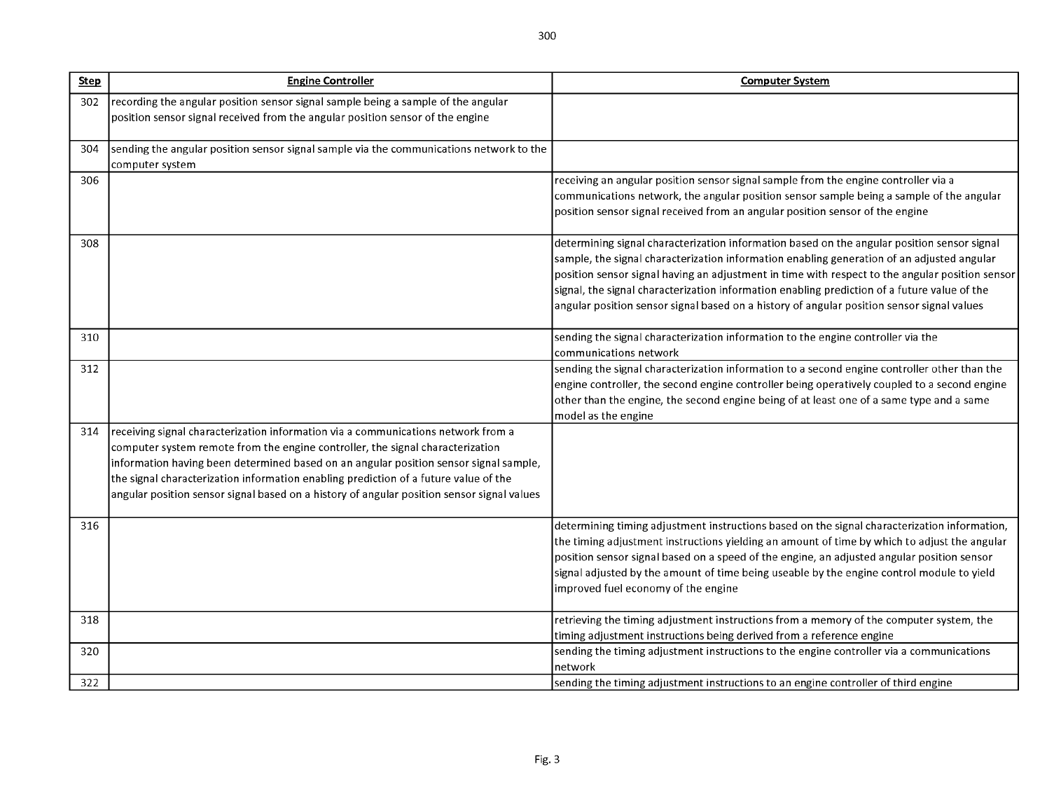

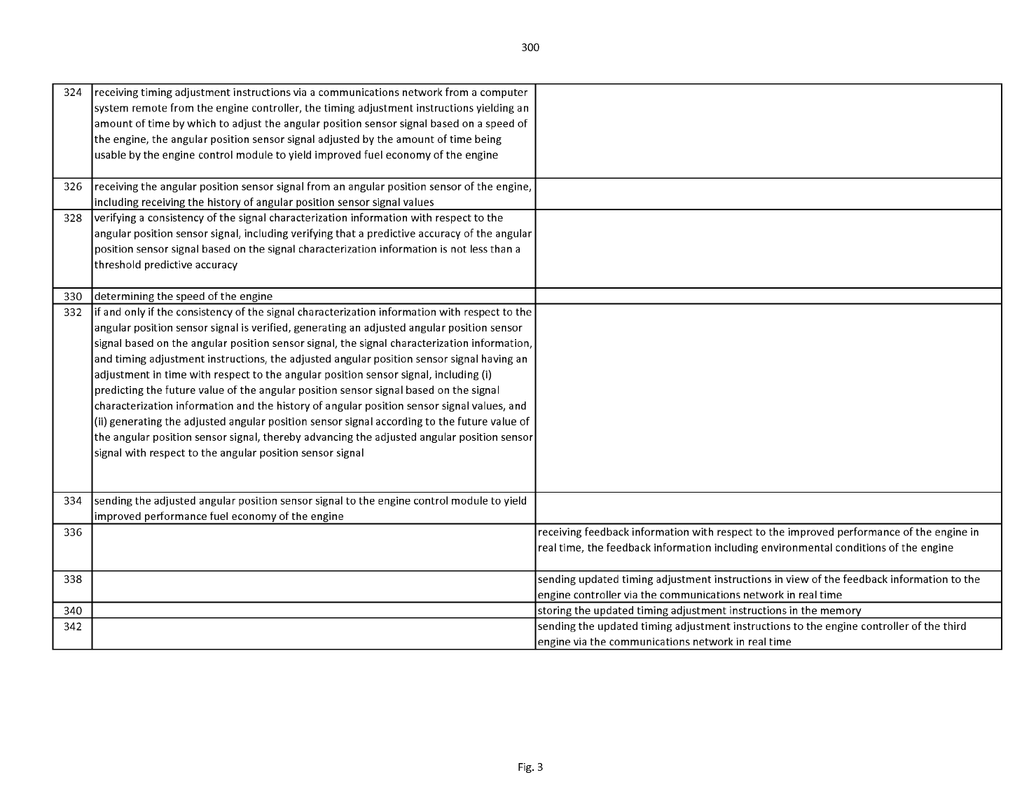

FIG. 2 depicts three engine controllers 110, 150, and 160, each of which is configured to adjust a respective angular position sensor signal received from a respective angular position sensor of a respective engine 130, 170, 180. In an exemplary configuration, engines 130, 170, and 180 are each the same model (e.g. a CAT™ C15™ in-line six cylinder diesel engine manufactured by Caterpillar, Inc. of Peoria, Ill., USA) and are each installed in earth-movers. Each of the engine controllers 110, 150, 160 was installed with respect to their respect engine 130, 170, 180 as was described hereinabove. As is shown in FIG. 3, each of the engine controllers 110, 150, and 160 is in communication with remote computer 120 via communications network 101. As those skilled in the art will readily understand, the network configuration shown is just one example of a network enabling communication of information between the remote computer 120 and each of the engine controllers 110, 150, and 160. The networked configuration of the engine controllers allows for propagation of various signal characterization information, timing adjustment instructions, and feedback information, as will be described in more detail below with reference to the exemplary processes of FIG. 3. Many other network topologies are possible, so long as each of the engine controllers 110, 150, and 160 is able to communicate with remote computer 120.

FIG. 3 provides a flowchart showing an example of interaction 300 between an engine controller and a computer system remote from the engine controller in one implementation, for example the engine controller 110 and remote computer 120 depicted in FIGS. 1 and 2. For purposes of this example, it is assumed that the engine controller 110 has been installed as described hereinabove but has not been otherwise configured nor previously used. It should be understood that only major steps in the operation of the engine controller 110 and the remote computer 120 will be described in the paragraph that follows. Minor steps (e.g. powering on the remote computer, for example), while important, are within the skill of a person skilled in the art and are not described herein for the purpose of brevity.

Thus, at step 302, engine controller 110 records a sample of an angular position sensor signal 133 received from angular position sensor 132 of engine 130. At step 304, engine controller 110 sends the sample to remote computer 120 via communications network 101. At step 306, remote computer 120 receives the sample from engine controller 110. (It should be noted that in other implementations, the sample could be received from another engine controller having recorded a sample of angular position sensor signal generated by an engine of the same type and/or model as engine 130, for example from engine controller 160 having recorded a sample of the angular position sensor signal of engine 180 (depicted in FIG. 2)). At step 308, remote computer 120 determines signal characterization information based on the sample, for example as described in the WO '487 patent publication. The signal characterization information includes information enabling prediction of a future value of angular position sensor signal 133 based on a history of its values. At step 310, remote computer 120 sends the signal characterization information (including the history) to engine controller 110 via communications network 101. At step 312, remote computer 120 also sends the signal characterization information to engine controllers 150, 160 (depicted in FIG. 2) for use in adjusting the angular position sensor signal engine controller 150 receives from engine 170, 180. (In this example it will be assumed that a human operator of computer system 120 indicated to the computer system 120 that the engines 110, 150, 160 were all of the same type and model.) At step 314, engine controller 110 receives the signal characterization information. (It will be understood that engine controllers 150, 160 receive the characterization information as well, but for sake of brevity, additional steps with respect to engines 170, 180 may not be repeated herein.)

At step 316, remote computer 120 determines (e.g. calculates the timing adjustment instructions or selects from among pre-calculated timing adjustment instructions) which timing adjustment instructions to send to engine controller 110 based on the signal characterization information. In this exemplary implementation, timing adjustment instructions are selected from among pre-calculated timing adjustment instructions known to yield an amount of time by which to adjust the angular position sensor signal 133 based on the speed of engine 130 so as to improve its fuel economy. At step 318, the selected timing adjustment instructions are retrieved from memory of remote computer 120, having been stored previously in the memory. At step 320, remote computer 120 sends the timing adjustment instructions to engine controller 110 for use in improving fuel economy of engine 130. At step 322, remote computer 120 also sends the timing adjustment instructions to engine controllers 150, 160 for use in improving the fuel economy of engines 170, 180. At step 324, engine controller 110 receives the timing adjustment instructions. (It will be understood that engine controllers 150, 160 receive the timing adjustment instructions as well, but for sake of brevity, additional steps with respect to engines 170, 180 may not be repeated herein.)

At step 326, engine controller 120 receives (i.e. reads) the angular position sensor signal 133 from the angular position sensor 132 of engine 130, and observes that the angular position sensor signal 133 includes the history of values enabling it to predict a future value of the angular position sensor signal 133 using the signal characterization information. At step 328, engine controller 110 verifies the consistency of the signal characterization information with respect to the angular position sensor signal 133. In this exemplary implementation, engine controller 110 effects the verification by making predictions of future values of the angular position sensor signal 133 based on the signal characterization information and observed histories of values of the signal. It then compares the predicted future values to the actual values later received in order to calculate a predictive accuracy, and compares it to a threshold predictive accuracy (e.g. 90%). If the predictive accuracy is not less than the threshold predictive accuracy, the consistency of the signal characterization information with respect to the angular position sensor signal is verified. Other implementations may verify the consistency of the signal characterization information with respect to the angular position sensor signal by observing the presence or lack or features of waveform characteristics which are expected to appear in the angular position sensor signal based on the signal characterization information.

At step 330, engine controller 120 determines the speed of engine 130, for example from an engine speed sensor (not shown) connected to an engine control bus, or by observing the frequency with which repeating patterns (e.g. the characteristic portion) of the angular position sensor signal recur. At step 332, the engine controller 110 generates the adjusted angular position sensor signal 116 if and only if the verification at step 328 was successful. The adjusted angular position signal 116 is generated according to a predicted future value of the angular position sensor signal 133 based on the signal characterization information and the history of values observed at step 326, thereby advancing the adjusted angular position sensor signal 116 with respect to the angular position sensor signal 133. Adjusted angular position sensor signal 116 is generated with sufficient characteristics of angular position sensor signal 133 to maintain compatibility with engine control module 140. At step 334, engine controller 234 sends the adjusted angular position sensor signal 116 to engine control module 140 to yield improved fuel economy of engine 130.

In the exemplary implementation of FIG. 3, feedback information regarding the improved performance of engine 130 is later received by the remote computer 120 at step 336. The feedback information could be received from a device equipped with a sensor for detecting performance (e.g. fuel economy). The device could be engine controller 110 or another device. At step 338, updated timing adjustment instructions are then sent by remote computer 120 to engine controller 110 in “real-time” in view of the feedback information. For example, remote computer 120 may observe that a slight advance in fuel injection timing has led to improved performance of engine 130, and so may increase the amount of the advance in the hope of achieving still better performance. At step 340, remote computer 120 also stores the updated timing adjustment instructions so that they may later be retrieved and sent to engine controllers for use with engines of the same type or model (e.g. as effected at steps 218 and 220). At step 342, remote computer 120 sends the updated timing adjustment instructions to engine controllers 150 and 160, thus propagating the updated timing adjustment instructions having demonstrated the ability to improve performance of engine 130 for use with engines 170 and 180, being of the same model as engine 130 and thus likely to also benefit from the updated timing adjustment instructions.

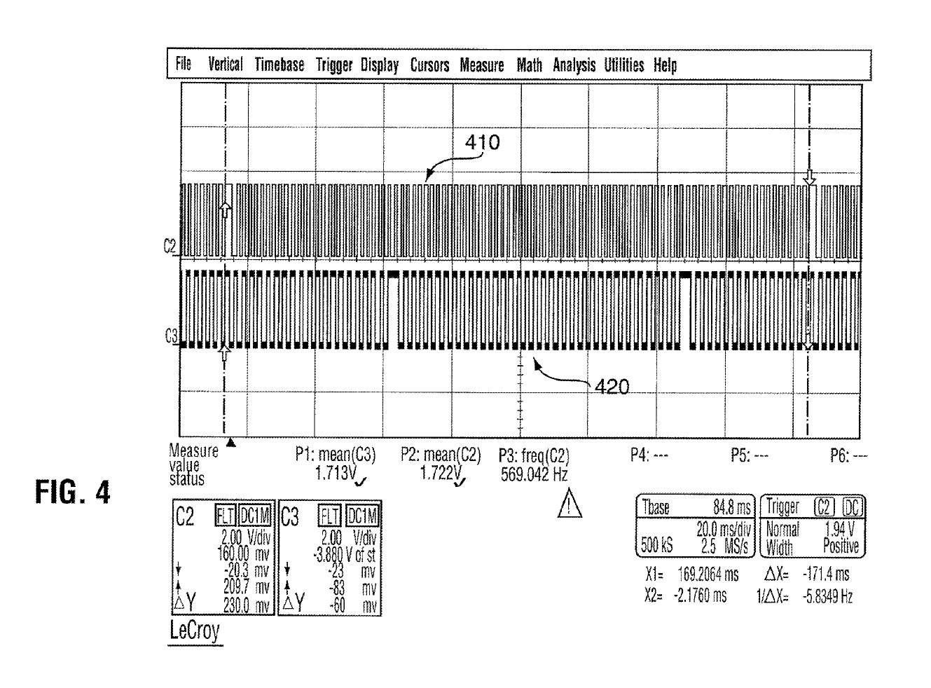

FIG. 4 shows an exemplary timing diagram for a CAT™ C15 truck engine. The timing diagram comprises an angular position sensor signal for the camshaft denoted by reference 410 and an angular position sensor signal for the crankshaft denoted by reference 420. According to this example, the camshaft signal 410 comprises 95 pulses for 720 degrees of revolution, and the crankshaft signal 420 comprises 35 pulses signifying 360 degrees of revolution.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of adjusting an angular position sensor signal of an engine operatively coupled to an engine controller, the method comprising, at the engine controller:
receiving signal characterization information via a communications network from a computer system remote from the engine controller, the signal characterization information having been determined based on an angular position sensor signal sample;
receiving the angular position sensor signal from an angular position sensor of the engine; and generating an adjusted angular position sensor signal based on the angular position sensor signal and the signal characterization information, the adjusted angular position sensor signal having an adjustment in time with respect to the angular position sensor signal.

2. The method of claim 1, wherein receiving the signal characterization information includes receiving signal characterization information enabling prediction of a future value of the angular position sensor signal based on a history of angular position sensor signal values.

3. The method of claim 2, wherein:
receiving the angular position sensor signal includes receiving the history of angular position sensor signal values; and
generating the adjusted angular position sensor signal includes (i) predicting the future value of the angular position sensor signal based on the signal characterization information and the history of angular position sensor signal values, and (ii) generating the adjusted angular position sensor signal according to the future value of the angular position sensor signal, thereby advancing the adjusted angular position sensor signal with respect to the angular position sensor signal.

4. The method of claim 1, further comprising verifying a consistency of the signal characterization information with respect to the angular position sensor signal.

5. The method of claim 4, wherein verifying the consistency of the signal characterization information with respect to the angular position sensor signal includes verifying that the angular position sensor signal includes a waveform characteristic that is expected based on the signal characterization information.

6. The method of claim 5, wherein the angular position sensor signal includes a rectangular waveform, and the waveform characteristic is one selected from a group consisting of pulse width and number of pulses per engine revolution of the rectangular waveform.

7. The method of claim 5, wherein the waveform characteristic is a periodically repeating characteristic portion.

8. The method of claim 4, wherein
receiving the signal characterization information includes receiving signal characterization information enabling prediction of a future value of the angular position sensor signal based on a history of angular position sensor signal values; and
verifying the consistency of the signal characterization information with respect to the angular position sensor signal includes verifying that a predictive accuracy of the angular position sensor signal based on the signal characterization information is not less than a threshold predictive accuracy.

9. The method of claim 4, wherein generating an adjusted angular position sensor signal based on the angular position sensor signal and the signal characterization information is generating an adjusted angular position sensor signal based on the angular position sensor signal and the signal characterization information if and only if the consistency of the signal characterization information with respect to the angular position sensor signal is verified.

10. The method of claim 1, further comprising, prior to receiving the signal characterization information:
recording the angular position sensor signal sample being a sample of the angular position sensor signal received from the angular position sensor of the engine; and
sending the angular position sensor signal sample via the communications network to the computer system.

11. The method of claim 1, wherein the angular position sensor signal sample is a sample of an angular position sensor signal of a second engine other than the engine, the second engine being of at least one of a same type and a same model as the engine.

12. The method of claim 1, wherein generating an adjusted angular position sensor signal based on the angular position sensor signal and the signal characterization information is generating an adjusted angular position sensor signal based on the angular position sensor signal, the signal characterization information, and timing adjustment instructions.

13. The method of claim 1, wherein the adjustment in time is zero.

14. The method of claim 1, further comprising, after generating the adjusted angular position sensor signal, sending the adjusted angular position sensor signal to an engine control module configured to control fuel injection of the engine based on received angular position sensor signals.

15. A method of remotely characterizing an angular position sensor signal of an engine operatively coupled to an engine controller, the method comprising, at a computer system remote from the engine controller: receiving an angular position sensor signal sample from the engine controller via a communications network, the angular position sensor sample being a sample of the angular position sensor signal received from an angular position sensor of the engine;
determining signal characterization information based on the angular position sensor signal sample, the signal characterization information enabling generation of an adjusted angular position sensor signal having an adjustment in time with respect to the angular position sensor signal; and sending the signal characterization information to the engine controller via the communications network.

16. The method of claim 15, wherein:
determining the signal characterization information includes determining signal characterization information enabling prediction of a future value of the angular position sensor signal based on a history of angular position sensor signal values; and
sending the signal characterization information includes sending the signal characterization information enabling prediction of the future value of the angular position sensor signal based on the history of angular position sensor signal values.

17. The method of claim 15, further comprising sending the signal characterization information to a second engine controller other than the engine controller, the second engine controller being operatively coupled to a second engine other than the engine, the second engine being of at least one of a same type and a same model as the engine.

18. A method of improving performance of an engine according to a performance metric, the engine including an engine control module structured and configured to control fuel injection timing of the engine based on an angular position sensor signal from an angular position sensor of the engine, the method comprising, at an engine controller operatively coupled to the angular position sensor and the engine control module:
receiving timing adjustment instructions via a communications network from a computer system remote from the engine controller, the timing adjustment instructions yielding an amount of time by which to adjust the angular position sensor signal based on an operating condition of the engine, the angular position sensor signal adjusted by the amount of time being usable by the engine control module to yield improved performance of the engine according to the performance metric; receiving the angular position sensor signal from the angular position sensor;
determining the operating condition of the engine;
generating an adjusted angular position sensor signal having an adjustment in time with respect to the angular position sensor signal by the amount of time yielded by the timing adjustment instructions based on the operating condition of the engine, the adjusted angular position sensor signal being generated with sufficient characteristics of the angular position sensor signal to be compatible with the engine control module; and
sending the adjusted angular position sensor signal to the engine control module to yield improved performance of the engine according to the performance metric.

19. The method of claim 18, wherein the performance metric is at least one of fuel economy and emissions output.

20. The method of claim 18, wherein the operating condition of the engine is one of a load of the engine and a speed of the engine.

21. The method of claim 18, wherein generating the adjusted angular position sensor signal includes generating the adjusted angular position sensor signal based on the angular position sensor signal and signal characterization information.

22. The method of claim 21, wherein the computer system is a first computer system, and further comprising receiving the signal characterization information via the communications network from a second computer system remote from the engine controller, the signal characterization information having been determined based on an angular position sensor signal sample.

23. The method of claim 22, wherein receiving the signal characterization information includes receiving signal characterization information enabling prediction of a future value of the angular position sensor signal based on a history of angular position sensor signal values.

24. The method of claim 23, wherein:
receiving the angular position sensor signal includes receiving the history of angular position sensor signal values; and
generating the adjusted angular position sensor signal includes (i) predicting the future value of the angular position sensor signal based on the signal characterization information and the history of angular position sensor signal values and (ii) generating the adjusted angular position sensor signal according to the future value of the angular position sensor signal, thereby advancing the adjusted angular position sensor signal with respect to the angular position sensor signal.

25. The method of claim 22, further comprising verifying a consistency of the signal characterization information with respect to the angular position sensor signal.

26. The method of claim 25, wherein verifying the consistency of the signal characterization information with respect to the angular position sensor signal includes verifying that the angular position sensor signal includes a waveform characteristic that is expected based on the signal characterization information.

27. The method of claim 26, wherein the angular position sensor signal includes a rectangular waveform, and the waveform characteristic is one selected from a group consisting of pulse width and number of pulses per engine revolution of the rectangular waveform.

28. The method of claim 26, wherein the waveform characteristic is a periodically repeating characteristic portion.

29. The method of claim 23, further comprising verifying a consistency of the signal characterization information with respect to the angular position sensor signal and wherein verifying the consistency of the signal characterization information with respect to the angular position sensor signal includes verifying that a predictive accuracy of the angular position sensor signal based on the signal characterization information is not less than a threshold predictive accuracy.

30. The method of claim 25, wherein generating an adjusted angular position sensor signal based on the angular position sensor signal and the signal characterization information is generating an adjusted angular position sensor signal based on the angular position sensor signal and the signal characterization information if and only if the consistency of the signal characterization information with respect to the angular position sensor signal is verified.

31. The method of claim 22, further comprising, prior to receiving the signal characterization information via the communications network from a second computer system remote from the engine controller:
recording the angular position sensor signal sample being a sample of the angular position sensor signal received from the angular position sensor of the engine; and
sending the angular position sensor signal sample via the communications network to the second computer system.

32. The method of claim 22, wherein the angular position sensor signal sample is a sample of an angular position sensor signal of a second engine other than the engine, the second engine being of at least one of a same type and a same model as the engine.

33. The method of claim 22, wherein the second computer system is the first computer system.

34. A method of improving performance of an engine according to a performance metric, the engine including (i) an engine control module structured and configured to control fuel injection timing of the engine based on an angular position sensor signal from an angular position sensor of the engine and (ii) an engine controller operatively coupled to the angular position sensor and the engine control module, the method comprising, at a computer system remote from the engine controller: determining timing adjustment instructions yielding an amount of time by which to adjust the angular position sensor signal based on an operating condition of the engine, an adjusted angular position sensor signal adjusted by the amount of time being useable by the engine control module to yield improved performance of the engine according to the performance metric; and
sending the timing adjustment instructions to the engine controller via a communications network.

35. The method of claim 34, wherein the performance metric is at least one of fuel economy and emissions output.

36. The method of claim 34, wherein the operating condition of the engine is one of a load of the engine and a speed of the engine.

37. The method of claim 34, wherein determining the timing adjustment instructions includes receiving an indication of at least one of a type and a model of the engine from a user of the computer system.

38. The method of claim 34, further comprising, prior to determining the timing adjustment instructions:
receiving an angular position sensor signal sample from the engine controller via the communications network;
determining signal characterization information based on the angular position sensor signal sample, the signal characterization information enabling generation of the adjusted angular position sensor signal; and
sending the signal characterization information to the engine controller via the communications network.

39. The method of claim 38, wherein determining the timing adjustment instructions includes determining the timing adjustment instructions based on the signal characterization information.

40. The method of claim 34, further comprising, after determining the timing adjustment instructions and before sending the timing adjustment instructions, retrieving the timing adjustment instructions from a memory of the computer system.

41. The method of claim 40, wherein the timing adjustment instructions are derived from second engine other than the engine.

42. The method of claim 41, wherein the second engine is a reference engine.

43. The method of claim 40, further comprising sending the timing adjustment instructions to an engine controller of a third engine.

44. The method of claim 34, further comprising receiving feedback information with respect to the improved performance of the engine.

45. The method of claim 44, wherein the feedback information includes information with respect to at least one of location information of the engine and environmental conditions of the engine.

46. The method of claim 44, further comprising, after receiving the feedback information, sending updated timing adjustment instructions in view of the feedback information to the engine controller via the communications network.

47. The method of claim 46 further comprising:
sending the timing adjustment instructions to an engine controller of a third engine;
storing the updated timing adjustment instructions in the memory; and
sending the updated timing adjustment instructions to the engine controller of the third engine via the communications network.

48. The method of claim 44, wherein the following occur in real-time:
receiving feedback information with respect to the improved performance of the engine;
and sending updated timing adjustment instructions in view of the feedback information to the engine controller via the communications network.

49. The method of claim 44, wherein the following occur in real-time:
receiving feedback information with respect to the improved performance of the engine;
and sending updated timing adjustment instructions in view of the feedback information to the engine controller of the third engine via the communications network.

50. An engine controller suitable for intercepting and adjusting an angular position sensor signal from an angular position sensor of an engine being communicated to an engine control module of the engine, the engine controller comprising:
a communications interface for communicating with a computer system remote from the engine;
an input port for receiving the angular position sensor signal;
an output port for sending an adjusted engine actuator signal to the engine control module in place of the angular position sensor signal; and
an electronic module configured for receiving the angular position sensor signal via the input port,
receiving at least one of signal characterization information, a history of angular position sensor signal values, and timing adjustment instructions from the computer system via the communications interface,
predicting a future value of the angular position sensor signal based on signal characterization information and a history of angular position sensor signal values,
generating the adjusted angular position sensor signal according to the future value of the angular position sensor signal, the adjusted angular position sensor signal having a time shift with respect to the received angular position sensor signal by an amount of time set according to timing adjustment instructions, and sending the adjusted angular position sensor signal via the output port.

51. The engine controller of claim 50, wherein the performance metric is at least one of fuel economy and emissions output.

52. The engine controller of claim 50, wherein the electronic module includes at least one processor and a memory having program instructions.

53. The engine controller of claim 50, wherein the electronic module includes at least one of a field-programmable gate array and an application-specific integrated circuit.

54. The engine controller of claim 50, wherein the electronic module is configured for receiving each of the signal characterization information, the history of angular position sensor signal value, and the timing adjustment instructions from the computer system via the communications interface.

55. The engine controller of claim 50, wherein the electronic module is further configured for sending an angular position sensor signal sample to the computer system via the communications interface.

56. The engine controller of claim 50, wherein the electronic module is further configured for verifying a consistency of signal characterization information received from the computer system with respect to the received angular position sensor signal.

57. The engine controller of claim 56, wherein verifying the consistency of the signal characterization information received from the computer system with respect to the received angular position sensor signal includes verifying that the received angular position sensor signal includes a waveform characteristic that is expected based on the received signal characterization information.

58. The engine controller of claim 57, wherein the received angular position sensor signal includes a rectangular waveform, and the waveform characteristic is one selected from a group consisting of pulse width and number of pulses per engine revolution of the rectangular waveform.

59. The engine controller of claim 57, wherein the waveform characteristic is a periodically repeating characteristic portion.

60. The engine controller of claim 56, wherein verifying the consistency of the signal characterization information received from the computer system with respect to the received angular position sensor signal includes verifying that a predictive accuracy of the received angular position sensor signal based on the signal characterization information received from the computer system is not less than a threshold predictive accuracy.

61. The engine controller of claim 56, wherein generating the adjusted angular position sensor signal is generating the adjusted angular position sensor signal if and only if the consistency of the signal characterization information received from the computer system with respect to the received angular position sensor signal is verified.

62. The engine controller of claim 50, wherein the electronic module is further configured for sending feedback information to the computer system via the communications interface.

63. A computer system for improving performance of an engine according to a performance metric, the engine including (i) an engine control module structured and configured to control fuel injection timing of the engine based on an angular position sensor signal from an angular position sensor of the engine and (ii) an engine controller operatively coupled to the angular position sensor and the engine control module, the computer system comprising:
a communications interface for communicating with the engine controller via a communications network;
at least one processor;
a first memory in communication with the at least one processor;
a second memory having program instructions executable by the at least one processor to effect
determining timing adjustment instructions yielding an amount of time by which to adjust the angular position sensor signal based on an operating condition of the engine, an adjusted angular position sensor signal adjusted by the amount of time being useable by the engine control module to yield improved performance of the engine according to the performance metric, and sending the timing adjustment instructions to the engine controller via the communications network;
the computer system being remote from the engine.

64. The computer system of claim 63, wherein the performance metric is at least one of fuel economy and emissions output.

65. The computer system of claim 63, wherein the program instructions further effect receiving an indication of the at least one of a type and a model of the engine from a user of the computer system.

66. The computer system of claim 65, wherein the program instructions, prior to determining the timing adjustment instructions, further effect:
receiving an angular position sensor signal sample from the engine controller via the communications network;
determining signal characterization information based on the angular position sensor signal sample, the signal characterization information enabling generation of the adjusted angular position; and
sending the signal characterization information to the engine controller via the communications network.

67. The computer system of claim 66, wherein determining the timing adjustment instructions includes determining the timing adjustment instructions based on the signal characterization information.

68. The computer system of claim 63, wherein the program instructions further effect, after determining timing adjustment instructions and before sending the timing adjustment instructions, retrieving the timing adjustment instructions from the first memory.

69. The computer system of claim 68, wherein the timing adjustment instructions are derived from a second engine other than the engine.

70. The computer system of claim 69, wherein the second engine is a reference engine.

71. The computer system of claim 68, wherein the program instructions further effect sending timing adjustment instructions to an engine controller of a third engine.

72. The computer system of claim 63, wherein the program instructions further effect receiving feedback information with respect to the improved performance of the engine.

73. The computer system of claim 72, wherein the feedback information includes information with respect to at least one of location information of the engine and environmental conditions of the engine.

74. The computer system of claim 72, wherein the program instructions further effect, after receiving the feedback information, sending updated timing adjustment instructions in view of the feedback information to the engine controller via the communications network.

75. The computer system of claim 74, wherein the program instructions further effect:
sending timing adjustment instructions to an engine controller of a third engine;
storing the updated timing adjustment instructions in the first memory; and
sending the updated timing adjustment instructions to the engine controller of the third engine via the communications network.

76. The computer system of claim 72, wherein the program instructions effect the following occurring in real-time:
receiving feedback information with respect to the improved performance of the engine;
and sending updated timing adjustment instructions in view of the feedback information to the engine controller via the communications network.

77. The computer system of claim 72, wherein the program instructions effect the following occurring in real-time:
receiving feedback information with respect to the improved performance of the engine;
and sending updated timing adjustment instructions in view of the feedback information to the engine controller of the third engine via the communications network
